(19) United States
(12) Patent Application Publication
(10) Pub. No.: US 2025/0267728 A1
(43) Pub. Date: Aug. 21, 2025

(54) FREQUENCY RANGE OR FREQUENCY BAND SPECIFIC VISIBLE INTERRUPTION LENGTH SETTING FOR NETWORK CONTROLLED SMALL GAP FOR A USER EQUIPMENT MEASUREMENT

(71) Applicant: Apple Inc., Cupertino, CA (US)

(72) Inventors: Qiming Li, Beijing (CN); Jie Cui, San Jose, CA (US); Dawei Zhang, Saratoga, CA (US); Yang Tang, San Jose, CA (US); Manasa Raghavan, Sunnyvale, CA (US); Xiang Chen, Campbell, CA (US); Huaning Niu, San Jose, CA (US)

(21) Appl. No.: 18/859,424

(22) PCT Filed: May 30, 2022
(86) PCT No.: PCT/CN2022/095922

§ 371 Date: Oct. 23, 2024

(51) Int. Cl. H04W 74/0833; H04L 27/26; H04W 8/22; H04W 24/10; H04W 56/00

(52) U.S. Cl. CPC H04W 74/0841; H04L 27/26025; H04W 8/22; H04W 24/10; H04W 56/0045

(57) ABSTRACT

A user equipment (UE) includes a transceiver and a processor. The processor is configured to transmit, from the UE to a base station, and via the transceiver, UE capability information identifying a visible interruption length type (VIL-type) supported by the UE. The processor is configured to receive, from the base station, and via the transceiver, a visible interruption length (VIL) configuration. The VIL configuration corresponds with the UE capability information transmitted to the base station, and a frequency range for performing measurements.

### TECHNICAL FIELD

This application relates generally to wireless communication systems, including methods and systems for provisioning a frequency band or a frequency range specific visible interruption length (VIL) setting for network controlled small gap (NCSG) for a user equipment (UE) measurement.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2 illustrates example network controlled small gap (NCSG) configuration parameters, according to embodiments described herein.

FIG. 3 illustrates an example visible interruption length (VIL) design for a NCSG, for two different subcarrier spacings (SCSs) of a frequency band or a frequency range, according to embodiments described herein.

FIG. 4A illustrates an example measurement gap timing advance (MGTA) design, represented using time slots of a transmission frame, for an example subcarrier spacing (SCS) for a frequency band or a frequency range, according to embodiments described herein.

FIG. 4B illustrates another example MGTA design, represented using time slots of a transmission frame, for another example subcarrier spacing (SCS) for a frequency band or a frequency range, according to embodiments described herein.

FIG. 5 illustrates an example flow-chart of operations being performed by a UE, according to embodiments described herein.

FIG. 6 illustrates an example flow-chart of operations being performed by a base station, according to embodiments described herein.

FIG. 7 illustrates an example flow-chart of method operations for provisioning of a UE for VIL, according to embodiments described herein.

FIG. 8 illustrates an example architecture of a wireless communication system, according to embodiments disclosed herein.

FIG. 9 illustrates a system for performing signaling between a wireless device and a network device, according to embodiments disclosed herein.

### DETAILED DESCRIPTION

In the present disclosure, various embodiments are related to measurement gap enhancements and, in particular, a NCSG used by 5G NR UEs in 71 GHz (FR2-2) frequency ranges. Currently, in 3GPP Technical Specification (TS) 38.133, release 17, NCSG design supports measurement gap enhancements for FRI and FR2-1 frequency ranges only. Measurement gap enhancements for FR2-2 frequency range are unavailable. In addition, measurement gap enhancements for FR2-2 frequency range, as described herein, may support different values for visible interruption length (VIL), based on a VIL type supported by a user equipment (UE).

For example, a UE may be communicatively coupled with one or more base stations, for data communication in an uplink direction and/or downlink direction, using one or more frequency bands or frequency ranges of one or more carriers. Accordingly, the UE may transmit to the base station, and/or receive from the base station, data in a carrier aggregation mode or a non-carrier aggregation (non-CA) mode. The UE may periodically perform measurements, for example, regarding signal quality measurements, and so on, and send measurement reports to the base station and/or a core network. While the UE is performing measurements during a period, which may be referenced herein as a measurement length (ML) period, the UE may need a time set aside for preparing its circuitry for performing measurements. The time that needs to be set aside for preparing the circuitry for performing measurements may vary based on an architecture of the baseband circuitry of the UE.

In some embodiments, a first period, which may be referenced herein as a visible interruption length-1 (VIL1), may precede the ML period and be used by the UE to prepare the UE for performing measurements. The VIL1 may include a radio frequency (RF) retuning time and a baseband preparation time. Similarly, a second period, which may be referenced herein as a visible interruption length-2 (VIL2), may follow the ML period and be used by the UE to prepare for other operations. The VIL2 may include an RF retuning time and a baseband preparation time. In some embodiments, and by way of a non-limiting example, during the VIL1 and/or VIL2, the UE may not transmit and/or receive data. In some cases, whether the UE may transmit and/or receive data during the ML period may depend on a scheduling restriction set by a serving carrier of the non-carrier aggregation or carrier aggregation mode of the UE's connection with the one or more base stations.

Accordingly, provisioning the UE for the VIL1 and/or VIL2 periods for an appropriate time, as required by the UE for RF retuning and baseband preparation, may allow the UE to transmit and/or receive data during the remaining time of a frame. The embodiments described herein provision the UE for the VIL1 and VIL2 periods for a frequency range or a frequency band, such as a frequency range 2-2 (FR2-2) that is a 71 GHz frequency range. Each of the VIL1 and VIL2 periods may correspond with a particular subcarrier spacing (SCS) configured on the FR2-2.

In some embodiments, and by way of a non-limiting example, the VIL1 and the VIL2 may have the same value. In some embodiments, the VIL1 may be different from the VIL2. The VIL1 and/or VIL2 may have a non-zero period. In some embodiments, the VIL1 and/or the VIL2 may be defined or indicated as a time in milliseconds (ms) and/or a number of interrupted slots. The interrupted slots are slots of a victim cell, such a cell in which interference by other neighboring aggressor cells may be detected.

In some embodiments, and by way of a non-limiting example, provisioning the UE for an appropriate VIL1 and/or VIL2 may depend on UE radio access capabilities. The UE radio access capabilities may depend on the architecture of UE circuitry, including baseband processing circuitry, and so on. The UE may thus be preconfigured to include a VIL type (VIL-type) supported by the UE in UE capability information, which UE capability may be transmitted to a base station in a radio resource control (RRC) message. In some cases, the VIL-type supported by the UE may be one of multiple VIL-type values, such as VIL type-1, VIL type-2, and so on.

In some embodiments, the VIL-type supported by the UE may be included in physical layer parameters, such as PHY-parameters, of the UE radio access capabilities parameters, of the UE capability information RRC message. Accordingly, the VIL-type included in the PHY-parameters may be per UE. In some cases, and by way of a non-limiting example, the VIL-type included in the PHY-parameters may be a mandatory parameter. However, the VIL-type included in the PHY-parameter may be an optional parameter in some cases. Further, the VIL-type included in PHY-parameters may have different values based on the frequency band or frequency range of one or more serving carrier frequency bands or frequency ranges of the UE.

The VIL1 and/or the VIL2, as described herein, include RF a retuning time and a baseband preparation time. However, the RF retuning time is a fraction of ms. The measurements that are performed by the UE are performed on synchronization signal blocks (SSBs). However, since the UE needs time for RF retuning, the UE may miss some of the SSBs allotted for UE measurements. To accommodate for the loss of SSBs for UE measurements or gap offset that is indicated based on ms granularity, but the RF retuning time of only a fraction of ms, in some embodiments, and by way of a non-limiting example, the UE may be instructed to advance the UE measurements by a measurement gap timing advance (MGTA) period. The MGTA period may be presented as a time in ms and/or a number of interrupted time slots. In some embodiments, the MGTA may be 0 ms, 0.25 ms, 0.5 ms, and/or 0.75 ms. The MGTA of 0.75 ms may be used to align with the VIL of 0.75 ms. Similarly, the MGTA of 0.5 ms may be used to align with the VIL of 0.5 ms. Here, VIL may refer to VIL1 and/or VIL2.

Various embodiments described herein provide measurement gap enhancements for the FR2-2. In particular, measurement gap enhancements for the FR2-2, as described herein, provision the UE for VIL configuration including VIL1 and/or VIL2 periods based on the VIL-type indicated by the UE, and/or a MGTA configuration indicating a MGTA.

Reference will now be made in detail to representative embodiments/aspects illustrated in the accompanying drawings. It should be understood that the following description is not intended to limit the embodiments to one preferred embodiment. On the contrary, it is intended to cover alternatives, combinations, modifications, and equivalents as can be included within the spirit and scope of the described embodiments as defined by the appended claims.

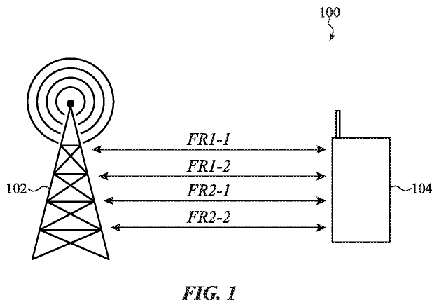

FIG. 1 shows an example wireless communication system, according to embodiments described herein. As shown in FIG. 1, a wireless communication system 100 may include a base station 102 that is communicatively coupled with a UE 104. In some embodiments, the base station 102 may be an eNb, an eNodeB, a gNodeB, or an access point (AP) in a radio access network (RAN) and may support one or more radio access technologies, such as 4G, 5G new radio (5G NR), and so on. The UE 104 may be a phone, a smart phone, a tablet, a smartwatch, an Internet-of-Things (IoT), and so on.

In some embodiments, and by way of a non-limiting example, as shown in the wireless communication system 100, the UE 104 may be connected with the base station in a carrier aggregation (CA) mode of one or more serving carriers. The UE 104 may thus send and/or receive data over one or more component carriers of different frequency bands or frequency ranges, for example, FR1-1, FR1-2, FR2-1, and/or FR2-2. Even though the UE 104 is shown as connected with only a single base station, the base station 102, in some cases, the UE may be connected with more than one base station in CA mode and/or non-CA mode. In some embodiments, and by way of a non-limiting example, the UE 104 may also be connected with the base station 102 in non-CA mode. The UE 104 may be connected with the base station in non-CA mode using one or more frequency bands of frequency ranges, such as FR1-1, FR1-2, FR2-1, and/or FR2-2, and so on. In some cases, the UE 104 may also be connected to the base station 102 via more than one in carrier in the same frequency band or frequency range.

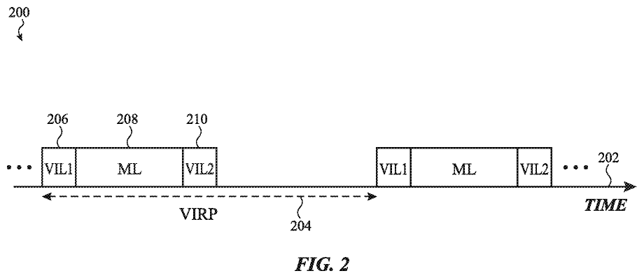

The UE 104 may periodically perform UE measurements and send measurement reports to the base station 102. FIG. 2 illustrates example network controlled small gap (NCSG) configuration parameters, according to embodiments described herein, for UE measurements. As shown in a diagram 200 of FIG. 2, the UE 104 may perform UE measurements over a measurement length (ML) period 208 of a time 202. During the ML period 208, as described herein, the UE may send or receive data on a corresponding serving carrier, e.g., the serving carrier frequency band or frequency range for which the UE is currently performing UE measurements, and may depend on a scheduling restriction requirement. The scheduling restriction requirement may be as described in section 9.1.9.3 of TS 38.133.

Further, as described herein, the UE may need to tune its RF and baseband circuity for performing UE measurements. In some embodiments, a first period, which may be referenced herein as a visible interruption length-1 (VIL1), shown in FIG. 2 as 206, may precede the ML period 208 and be used by the UE 104 to prepare for the measurements. The VIL1 206 may include an RF retuning time and a baseband preparation time. Similarly, a second period, which may be referenced herein as a visible interruption length-2 (VIL2), shown in FIG. 2 as 210, may follow the ML period 208 and be used by the UE 104 to prepare for other operations. The VIL2 210 may include an RF retuning time and a baseband preparation time. In some embodiments, and by way of a non-limiting example, the UE 104 may not transmit and/or receive data during the VIL1 206 and/or VIL2 20. In some cases, whether the UE 104 may transmit and/or receive data during the ML period 208 may depend on a scheduling restriction set by a serving carrier of the non-carrier aggregation mode or carrier aggregation mode of the UE 104's connection with the one or more base stations, such as the base station 102.

Provisioning the UE 104 for the VIL1 period 206 and/or VIL2 period 210, for an appropriate time required by the UE 104 for RF retuning and baseband preparation, may allow the UE 104 to transmit and/or receive data during the remaining time of a frame. The embodiments described herein provision the UE 104 for the VIL1 and VIL2 periods 206 210 for a frequency range or a frequency band, such as a frequency range 2-2 (FR2-2) that is a 71 GHz frequency range. Each of the VIL1 and VIL2 periods 206 210 may correspond with a particular subcarrier spacing (SCS) configured on the FR2-2. In one example, the SCS may be 15 KHz, 30 KHz, 60 KHz, 120 KHz, 240 KHz, 480 KHz, 960 KHz, and so on.

As described herein, the UE may periodically perform measurements at a period identified in FIG. 2 as visible interruption repetition period (VIRP) 204. The VIRP 204 is thus a sum of VIL1 206, ML 208, and VIL2 210. In some embodiments, VIL1 206 and VIL2 210 may have the same value. In some embodiments, VIL1 206 may have a different value from VIL2 210. In some embodiments, and by way of a non-limiting example, VIL2 may have a different value from the VIL1, depending on whether the UE 104 is scheduled for UL or DL transmission following the VIL2 210.

In some embodiments, and by way of a non-limiting example, the VIL1 206 and the VIL2 210 may have the same value. In some cases, the VIL1 206 may be different from the VIL2 210. The VIL1 206 and/or VIL2 210 may be non-zero periods. In some embodiments, the VIL1 206 and/or the VIL2 210 may be defined or indicated as a time in milliseconds (ms) and/or a number of interrupted slots. The interrupted slots are slots of a victim cell, such a cell in which interference by other neighboring aggressor cells may be detected.

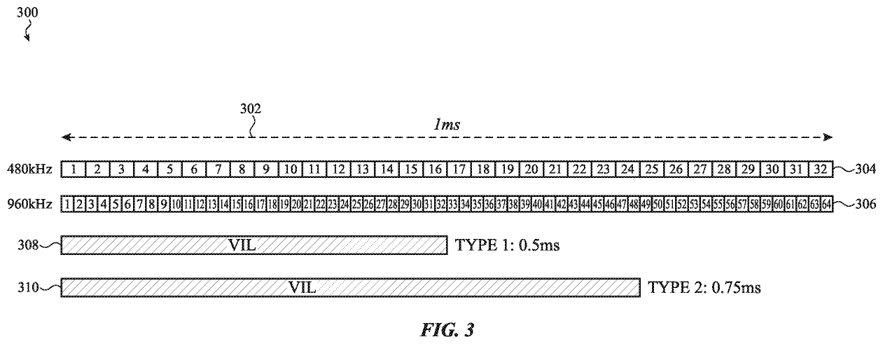

FIG. 3 illustrates an example visible interruption length (VIL) design for NCSG, for two different subcarrier spacings (SCSs) configured on a frequency band or a frequency range, according to embodiments described herein. In FIG. 3, a VIL design 300 for NCSG for a frequency range, such as FR2-2, for a frame 302 of 1 ms is shown for a SCS of 480 KHz and a SCS of 960 KHz. A frame of 1 ms for the SCS of 480 KHz 304 may have 32 time slots, and a frame of 1 ms for the SCS of 960 KHz 306 may have 64 time slots.

In some embodiments, and by way of a non-limiting example, for a VIL-type of type1, VIL1 206 and VIL2 210 may each have a value of 0.5 ms, shown in FIG. 3 as 308. The VIL1 206 and VIL2 210 of 0.5 ms may include an RF retuning time of 0.25 ms and a baseband preparation time of 0.25 ms. In some cases, for a VIL-type of type2, VIL1 206 and VIL2 210 may each have a value of 0.75 ms, shown in FIG. 3 as 310, that includes 0.25 ms of RF retuning time and 0.5 ms of baseband preparation time. Accordingly, VIL1 206 and VIL2 210 of 0.5 ms may correspond to 16 or 32 time slots for the SCS of 480 KHz or 960 KHz, respectively. Similarly, VIL1 206 and VIL2 210 of 0.75 ms may correspond to 24 or 48 time slots for the SCS of 480 KHz or 960 KHz, respectively. In some embodiments, and by way of a non-limiting example, VIL1 206 and/or VIL2 210 may have a value other than 0.5 ms or 0.75 ms. Further, VIL1 206 and/or VIL2 210 may have an RF retuning time other than 0.25 ms, and a baseband preparation time other than 0.25 ms and/or 0.5 ms.

As described herein, the VIL1 206 and/or the VIL2 210, may include RF retuning time and baseband preparation time. However, the RF retuning time is a fraction of ms. The measurements that are performed by the UE 104 are performed on synchronization signal blocks (SSBs). However, since the UE 104 needs time for RF retuning, the UE may miss some of the SSBs allotted for UE measurements. To accommodate for the loss of SSBs for the UE measurements, in some embodiments, and by way of a non-limiting example, the UE 104 may be instructed to advance the UE measurements by a measurement gap timing advance (MGTA) period.

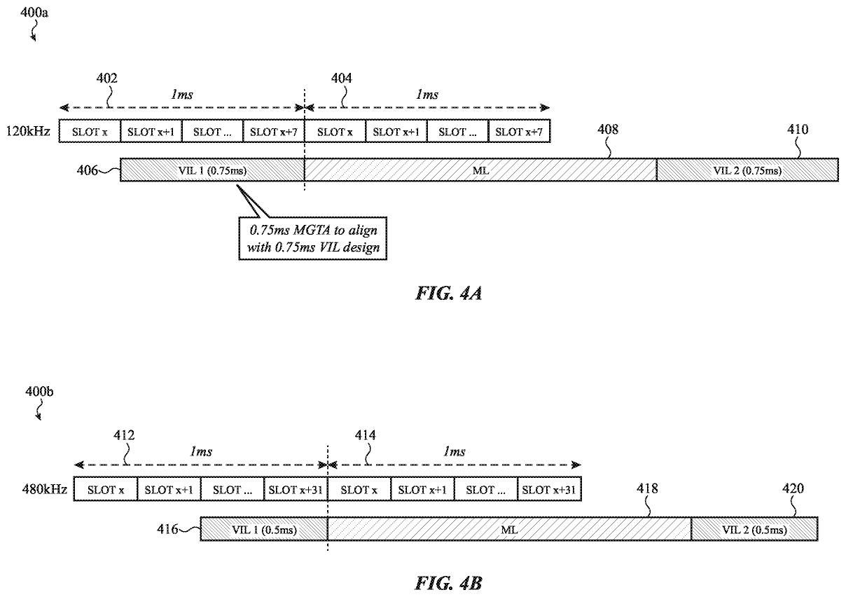

FIG. 4A illustrates an example MGTA design represented using time slots of a transmission frame for an example subcarrier spacing (SCS) configured on the frequency band or frequency range, according to embodiments described herein. As shown in diagram 400a of FIG. 4A, each 1 ms frame 402 404 may have 8 time slots, e.g., slot x, slot x+1, . . . , slot x+7, for a SCS of 120 KHz. Accordingly, the VIL1 206 and the VIL2 210 of 0.75 ms may correspond with six time slots, as shown in FIG. 4A as 406 and 410, respectively. Further, as described herein, VIL1 time slots 406 may precede time slots corresponding to ML 408, and VIL2 time slots 410 may follow time slots corresponding to ML 408, during which the UE 104 may perform UE measurements. Further, in accordance with some embodiments, and by way of a non-limiting example, the UE 104 may be instructed of MGTA of 0 ms, 0.25 ms, 0.5 ms, and/or 0.75 ms for the VIL1 of 0.75 ms. The number of time slots mentioned herein may correspond with a number of interrupted time slots. In some embodiments, and by way of a non-limiting example, the number of interrupted time slots for a SCS of 120 KHz may be 4, and the MGTA of 0 ms, 0.25 ms, 0.5 ms, and 0.75 ms may be applied for both VIL of 0.5 ms.

FIG. 4B illustrates another example MGTA design represented using time slots of a transmission frame for another example SCS configured on the frequency range or frequency band, according to embodiments described herein. As shown in diagram 400b of FIG. 4B, each 1 ms frame 412 414 may have 32 time slots, e.g., slot x, slot x+1, . . . , slot x+31, for a SCS of 480 KHz. Accordingly, the VIL1 206 and the VIL2 210 of 0.5 ms may correspond with sixteen time slots, as shown in FIG. 4B as 416 and 420, respectively. Further, as described herein, VIL1 time slots 416 may precede time slots corresponding to ML 418, and VIL2 time slots 420 may follow time slots corresponding to ML 418, during which the UE 104 may perform UE measurements. Further, in accordance with some embodiments, and by way of a non-limiting example, the UE 104 may be instructed of MGTA of 0 ms, 0.25 ms, 0.5 ms, and/or 0.75 ms for the VIL1 of 0.75 ms. The number of time slots mentioned herein may correspond with a number of interrupted time slots.

In some embodiments, and by way of a non-limiting example, the number of interrupted slots for a SCS of 960 KHz may be 32, and the MGTA of 0 ms, 0.25 ms, 0.5 ms, and 0.75 ms may be applied for both VIL of 0.5 ms. In some cases, the number of interrupted time slots for a SCS of 960 KHz may be 48, and the MGTA of 0 ms, 0.25 ms, 0.5 ms, and 0.75 ms may be applied for both VIL of 0.5 ms.

In some embodiments, and by way of a non-limiting example, non-overlapped half time slots may occur before VIL1 and/or after VIL2. During the non-overlapped half time slots, whether the UE 104 may transmit and/or receive data, may be UE-specific.

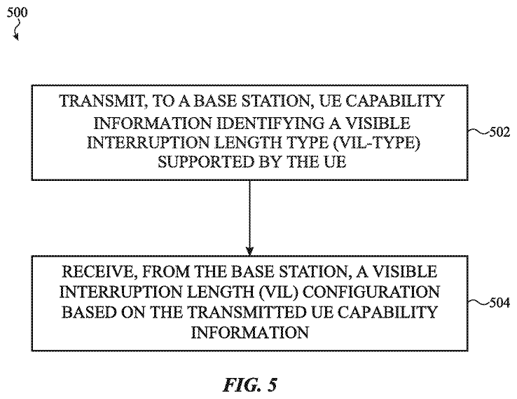

FIG. 5 illustrates an example flow-chart of operations being performed by a user equipment (UE), according to embodiments described herein. As shown in a flow-chart 500 of FIG. 5, at 502, the UE 104 may transmit UE capability information to the base station 102. The UE capability information may be transmitted using a radio resource control (RRC) signaling message. As described herein, the UE capability information may include physical layer parameters, such as PHY-parameters. A new parameter, such as a VIL-type may be included in the PHY-parameters. In some cases, and by way of a non-limiting example, the VIL-type included in the PHY-parameters may be a mandatory parameter. However, the VIL-type included in the PHY-parameter may also be an optional parameter, in some cases. Further, the VIL-type included in PHY-parameters may have different values based on the frequency band (or frequency range) of one or more serving carrier frequency bands (or frequency ranges) of the UE. The VIL-type included in the PHY-parameters may be determined by the UE based on physical layer parameters of a baseband processing circuitry of the UE. In other words, the VIL-type included in PHY-parameters and determined by the UE may depend on architecture and/or design of the baseband processing circuitry of the UE.

At 504, the UE 104 may receive, from the base station 102, visible interruption length (VIL) configuration. The VIL configuration may correspond with the UE capability information transmitted to the base station at 102. The VIL configuration may be per UE and specific to a particular frequency range for performing UE measurements. As described herein, the VIL configuration received by the UE 104 may be presented either as time in ms or a number of time slots, e.g., a number of interrupted time slots.

In some embodiments, and by way of a non-limiting example, the VIL configuration may include a first VIL period and a second VIL period. The first VIL period may precede before the ML period and may be referenced as VIL1. The second VIL period may follow the ML period and may be referenced as VIL2. Further, in some embodiments, the VIL1 and the VIL2 may have a different value.

In some embodiments, and by way of a non-limiting example, the UE may also receive MGTA configuration. As described herein, the MGTA configuration may be of 0 ms, 0.25 ms, 0.5 ms, and/or 0.75 ms to advance the UE measurements to compensate for loss of SSBs for UE measurements from RF retuning time.

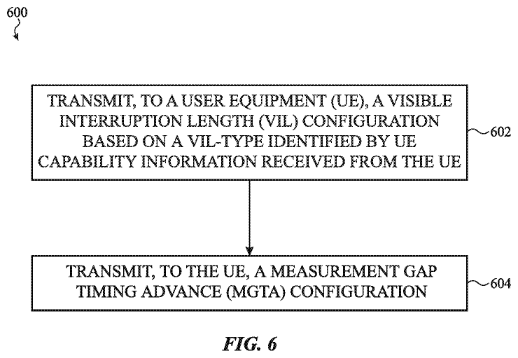

FIG. 6 illustrates an example flow-chart of operations being performed by a base station, according to embodiments described herein. As shown in a flow-chart 600 of FIG. 6, at 602, the base station 102 may transmit visible interruption length (VIL) configuration to the UE 104. The VIL configuration may correspond with the UE capability information received at the base station 102. The VIL configuration may be per UE and specific to a particular frequency range for performing UE measurements. As described herein, the VIL configuration may identify time in ms or a number of time slots, e.g., a number of interrupted time slots, during which the UE may not transmit and/or receive data.

In some embodiments, and by way of a non-limiting example, the VIL configuration may include a first VIL period and a second VIL period. The first VIL period may precede before the ML period and may be referenced as VIL1. The second VIL period may follow the ML period and may be referenced as VIL2. Further, in some embodiments, the VIL1 and the VIL2 may have a different value.

In some embodiments, the VIL configuration may be based on UE capability information received at the base station 102 from the UE 104. The UE capability information may be received using radio resource control (RRC) signaling message. As described herein, the UE capability information may include physical layer parameters, such as PHY-parameters. A new parameter, such as a VIL-type, may be included in the PHY-parameters. In some cases, and by way of a non-limiting example, the VIL-type included in the PHY-parameters may be a mandatory parameter. However, the VIL-type included in the PHY-parameter may also be an optional parameter in some cases. As described herein, the VIL-type is determined based on physical layer (PHY) parameters of baseband circuitry of the UE. In some embodiments, and by way of a non-limiting example, a VIL configuration may include VIL1 and VIL2 of 0.75 ms when the VIL-type is not included in the PHY-parameters in UE capability information. However, other values of VIL1 and VIL2, such as 0.5 ms, may also be set when the VIL-type is not included in the PHY-parameters in UE capability information.

At 604, the base station 102 may transmit an MGTA configuration to the UE 104. As described herein, the MGTA configuration may be of 0 ms, 0.25 ms, 0.5 ms, and/or 0.75 ms to advance the UE measurements to compensate for loss of SSBs for UE measurements from RF retuning time. The MGTA configuration may correspond with the VIL configuration. In other words, the MGTA configuration may also depend on the VIL-type received from the UE 104 at the base station 102.

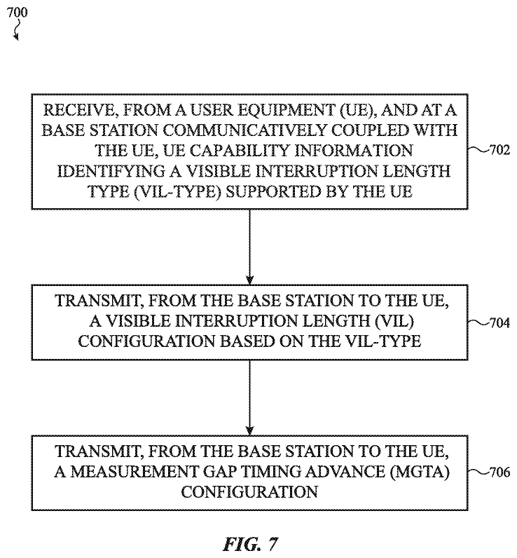

FIG. 7 illustrates an example flow-chart of method operations for provisioning of a UE for VIL, according to embodiments described herein. As shown in a flow-chart 700 of FIG. 7, at 702, UE capability information identifying visible interruption length type (VIL-type) supported by a UE may be received by a base station from the UE, as described herein, in accordance with some embodiments. The VIL-type may identify PHY-parameters supported by the UE.

At 704, based on the received UE capability information, the base station may transmit, to the UE, a visible interruption length (VIL) configuration for performing UE measurements. As described herein, the VIL configuration may include a VIL as a number of interrupted slots or time in milliseconds (ms). Since the VIL configuration is described in detail earlier, those details are not being repeated here for brevity.

At 706, the base station may transmit, to the UE, measurement gap timing advance (MGTA) configuration. The MGTA configuration may be according to the VIL configuration, and include MGTA as a number of interrupted slots or time in ms. Since the MGTA configuration is described in detail earlier, those details are not being repeated here for brevity.

Embodiments contemplated herein include an apparatus having means to perform one or more elements of the method 500, 600, or 700. In the context of method 500, this apparatus may be, for example, an apparatus of a UE (such as a wireless device 902 that is a UE, as described herein). In the context of method 600, or 700, this apparatus may be, for example, an apparatus of a base station (such as a network device 920 that is a base station, as described herein).

Embodiments contemplated herein include one or more non-transitory computer-readable media storing instructions to cause an electronic device, upon execution of the instructions by one or more processors of the electronic device, to perform one or more elements of the method 500, 600, or 700. In the context of method 500, this non-transitory computer-readable media may be, for example, a memory of a UE (such as a memory 906 of a wireless device 902 that is a UE, as described herein). In the context of method 600, or 700, this non-transitory computer-readable media may be, for example, a memory of a base station (such as a memory 924 of a network device 920 that is a base station, as described herein).

Embodiments contemplated herein include an apparatus having logic, modules, or circuitry to perform one or more elements of the method 500, 600, or 700. In the context of method 500, this apparatus may be, for example, an apparatus of a UE (such as a wireless device 902 that is a UE, as described herein). In the context of method 600, or 700, this apparatus may be, for example, an apparatus of a base station (such as a network device 920 that is a base station, as described herein).

Embodiments contemplated herein include an apparatus having one or more processors and one or more computer-readable media, using or storing instructions that, when executed by the one or more processors, cause the one or more processors to perform one or more elements of the method 500, 600, or 700. In the context of method 500, this apparatus may be, for example, an apparatus of a UE (such as a wireless device 902 that is a UE, as described herein). In the context of the method 600, or 700, this apparatus may be, for example, an apparatus of a base station (such as a network device 920 that is a base station, as described herein).

Embodiments contemplated herein include a signal as described in or related to one or more elements of the method 500, 600, or 700.

Embodiments contemplated herein include a computer program or computer program product having instructions, wherein execution of the program by a processor causes the processor to carry out one or more elements of the method 500, 600, or 700. In the context of method 500, the processor may be a processor of a UE (such as a processor(s) 904 of a wireless device 902 that is a UE, as described herein), and the instructions may be, for example, located in the processor and/or on a memory of the UE (such as a memory 906 of a wireless device 902 that is a UE, as described herein). In the context of method 600, or 700, the processor may be a processor of a base station (such as a processor(s) 922 of a network device 920 that is a base station, as described herein), and the instructions may be, for example, located in the processor and/or on a memory of the base station (such as a memory 924 of a network device 920 that is a base station, as described herein).

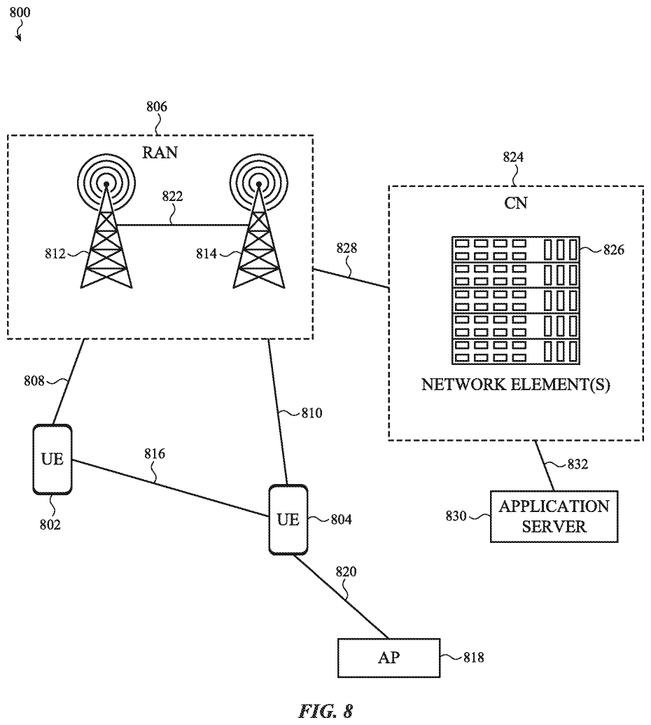

FIG. 8 illustrates an example architecture of a wireless communication system, according to embodiments disclosed herein. The following description is provided for an example wireless communication system 800 that operates in conjunction with the LTE system standards and/or 5G or NR system standards as provided by 3GPP technical specifications.

As shown by FIG. 8, the wireless communication system 800 includes UE 802 and UE 804 (although any number of UEs may be used). In this example, the UE 802 and the UE 804 are illustrated as smartphones (e.g., handheld touchscreen mobile computing devices connectable to one or more cellular networks), but may also comprise any mobile or non-mobile computing device configured for wireless communication.

The UE 802 and UE 804 may be configured to communicatively couple with a RAN 806. In embodiments, the RAN 806 may be NG-RAN, E-UTRAN, etc. The UE 802 and UE 804 utilize connections (or channels) (shown as connection 808 and connection 810, respectively) with the RAN 806, each of which comprises a physical communications interface. The RAN 806 can include one or more base stations, such as base station 812 and base station 814, that enable the connection 808 and connection 810.

In this example, the connection 808 and connection 810 are air interfaces to enable such communicative coupling, and may be consistent with RAT(s) used by the RAN 806, such as, for example, an LTE and/or NR.

In some embodiments, the UE 802 and UE 804 may also directly exchange communication data via a sidelink interface 816. The UE 804 is shown to be configured to access an access point (shown as AP 818) via connection 820. By way of example, the connection 820 can comprise a local wireless connection, such as a connection consistent with any IEEE 802.11 protocol, wherein the AP 818 may comprise a Wi-Fi® router. In this example, the AP 818 may be connected to another network (for example, the Internet) without going through a CN 824.

In embodiments, the UE 802 and UE 804 can be configured to communicate using orthogonal frequency division multiplexing (OFDM) communication signals with each other or with the base station 812 and/or the base station 814 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 812 or base station 814 may be implemented as one or more software entities running on server computers as part of a virtual network. In addition, or in other embodiments, the base station 812 or base station 814 may be configured to communicate with one another via interface 822. In embodiments where the wireless communication system 800 is an LTE system (e.g., when the CN 824 is an EPC), the interface 822 may be an X2 interface. The X2 interface may be defined between two or more base stations (e.g., two or more eNBs and the like) that connect to an EPC, and/or between two eNBs connecting to the EPC. In embodiments where the wireless communication system 800 is an NR system (e.g., when CN 824 is a 5GC), the interface 822 may be an Xn interface. The Xn interface is defined between two or more base stations (e.g., two or more gNBs and the like) that connect to 5GC, between a base station 812 (e.g., a gNB) connecting to 5GC and an eNB, and/or between two eNBs connecting to 5GC (e.g., CN 824).

The RAN 806 is shown to be communicatively coupled to the CN 824. The CN 824 may comprise one or more network elements 826, which are configured to offer various data and telecommunications services to customers/subscribers (e.g., users of UE 802 and UE 804) who are connected to the CN 824 via the RAN 806. The components of the CN 824 may be implemented in one physical device or separate physical devices including components to read and execute instructions from a machine-readable or computer-readable medium (e.g., a non-transitory machine-readable storage medium).

In embodiments, the CN 824 may be an EPC, and the RAN 806 may be connected with the CN 824 via an S1 interface 828. In embodiments, the S1 interface 828 may be split into two parts, an S1 user plane (S1-U) interface, which carries traffic data between the base station 812 or base station 814 and a serving gateway (S-GW), and the S1-MME interface, which is a signaling interface between the base station 812 or base station 814 and mobility management entities (MMEs).

In embodiments, the CN 824 may be a 5GC, and the RAN 806 may be connected with the CN 824 via an NG interface 828. In embodiments, the NG interface 828 may be split into two parts, an NG user plane (NG-U) interface, which carries traffic data between the base station 812 or base station 814 and a user plane function (UPF), and the S1 control plane (NG-C) interface, which is a signaling interface between the base station 812 or base station 814 and access and mobility management functions (AMFs).

Generally, an application server 830 may be an element offering applications that use internet protocol (IP) bearer resources with the CN 824 (e.g., packet switched data services). The application server 830 can also be configured to support one or more communication services (e.g., VoIP sessions, group communication sessions, etc.) for the UE 802 and UE 804 via the CN 824. The application server 830 may communicate with the CN 824 through an IP communications interface 832.

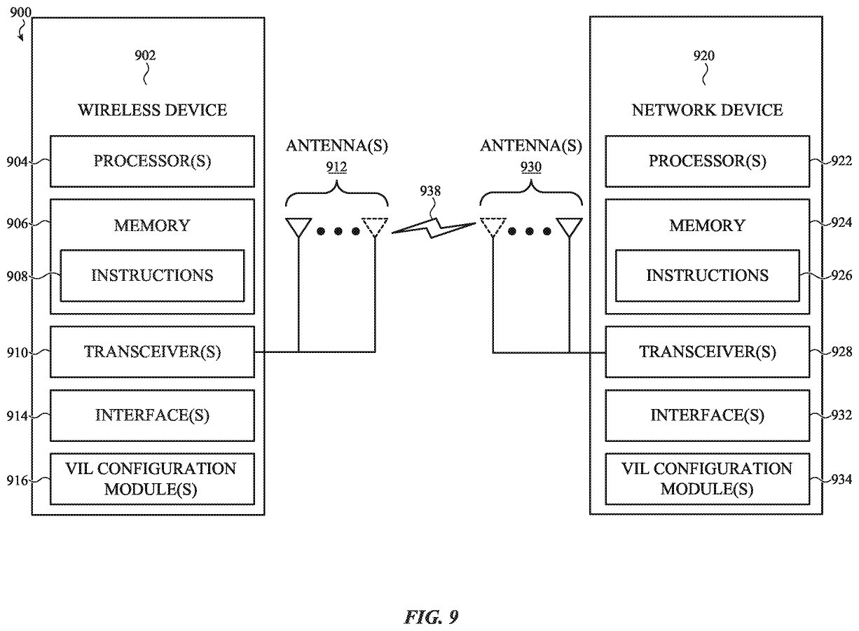

FIG. 9 illustrates a system 900 for performing signaling 938 between a wireless device 902 and a network device 920, according to embodiments disclosed herein. The system 900 may be a portion of a wireless communication system as herein described. The wireless device 902 may be, for example, a UE of a wireless communication system. The network device 920 may be, for example, a base station (e.g., an eNB or a gNB) of a wireless communication system.

The wireless device 902 may include one or more processor(s) 904. The processor(s) 904 may execute instructions such that various operations of the wireless device 902 are performed, as described herein. The processor(s) 904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 902 may include a memory 906. The memory 906 may be a non-transitory computer-readable storage medium that stores instructions 908 (which may include, for example, the instructions being executed by the processor(s) 904). The instructions 908 may also be referred to as program code or a computer program. The memory 906 may also store data used by, and results computed by, the processor(s) 904.

The wireless device 902 may include one or more transceiver(s) 910 that may include radio frequency (RF) transmitter and/or receiver circuitry that use the antenna(s) 912 of the wireless device 902 to facilitate signaling (e.g., the signaling 938) to and/or from the wireless device 902 with other devices (e.g., the network device 920) according to corresponding RATs.

The wireless device 902 may include one or more antenna(s) 912 (e.g., one, two, four, or more). For embodiments with multiple antenna(s) 912, the wireless device 902 may leverage the spatial diversity of such multiple antenna(s) 912 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 902 may be accomplished according to precoding (or digital beamforming) that is applied at the wireless device 902 that multiplexes the data streams across the antenna(s) 912 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 902 may implement analog beamforming techniques, whereby phases of the signals sent by the antenna(s) 912 are relatively adjusted such that the (joint) transmission of the antenna(s) 912 can be directed (this is sometimes referred to as beam steering).

The wireless device 902 may include one or more interface(s) 914. The interface(s) 914 may be used to provide input to or output from the wireless device 902. For example, a wireless device 902 that is a UE may include interface(s) 914 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 910/antenna(s) 912 already described) that allow for communication between the UE and other devices and may operate according to known protocols (e.g., Wi-Fi®, Bluetooth®, and the like).

The wireless device 902 may include a VIL configuration module 916. The VIL configuration module 916 may be implemented via hardware, software, or combinations thereof. For example, the VIL configuration module 916 may be implemented as a processor, circuit, and/or instructions 908 stored in the memory 906 and executed by the processor(s) 904. In some examples, the VIL configuration module 916 may be integrated within the processor(s) 904 and/or the transceiver(s) 910. For example, the VIL configuration module 916 may be implemented by a combination of software components (e.g., executed by a DSP or a general processor) and hardware components (e.g., logic gates and circuitry) within the processor(s) 904 or the transceiver(s) 910.

The VIL configuration module 916 may be used for various aspects of the present disclosure, for example, aspects of FIGS. 1-7. The VIL configuration module 916 may be configured to, for example, determine or identify a VIL-type and transmit it to the base station in UE capability information, and perform UE measurements based on a VIL configuration and/or a MGTA configuration received from the base station.

The network device 920 may include one or more processor(s) 922. The processor(s) 922 may execute instructions such that various operations of the network device 920 are performed, as described herein. The processor(s) 922 may include one or more baseband processors implemented using, for example, a CPU, a DSP, an ASIC, a controller, an FPGA device, another hardware device, a firmware device, or any combination thereof configured to perform the operations described herein.

The network device 920 may include a memory 924. The memory 924 may be a non-transitory computer-readable storage medium that stores instructions 926 (which may include, for example, the instructions being executed by the processor(s) 922). The instructions 926 may also be referred to as program code or a computer program. The memory 924 may also store data used by, and results computed by, the processor(s) 922.

The network device 920 may include one or more transceiver(s) 928 that may include RF transmitter and/or receiver circuitry that use the antenna(s) 930 of the network device 920 to facilitate signaling (e.g., the signaling 938) to and/or from the network device 920 with other devices (e.g., the wireless device 902) according to corresponding RATs.

The network device 920 may include one or more antenna(s) 930 (e.g., one, two, four, or more). In embodiments having multiple antenna(s) 930, the network device 920 may perform MIMO, digital beamforming, analog beamforming, beam steering, etc., as has been described.

The network device 920 may include one or more interface(s) 932. The interface(s) 932 may be used to provide input to or output from the network device 920. For example, a network device 920 that is a base station may include interface(s) 932 made up of transmitters, receivers, and other circuitry (e.g., other than the transceiver(s) 928/antenna(s) 930 already described) that enables the base station to communicate with other equipment in a core network, and/or that enables the base station to communicate with external networks, computers, databases, and the like for purposes of operations, administration, and maintenance of the base station or other equipment operably connected thereto.

The network device 920 may include a VIL configuration module 934. The VIL configuration module 934 may be implemented via hardware, software, or combinations thereof. For example, the VIL configuration module 934 may be implemented as a processor, circuit, and/or instructions 926 stored in the memory 924 and executed by the processor(s) 922. In some examples, the VIL configuration module 934 may be integrated within the processor(s) 922 and/or the transceiver(s) 928. For example, the VIL configuration module 934 may be implemented by a combination of software components (e.g., executed by a DSP or a general processor) and hardware components (e.g., logic gates and circuitry) within the processor(s) 922 or the transceiver(s) 928.

The VIL configuration module 934 may be used for various aspects of the present disclosure, for example, aspects of FIGS. 1-7. The VIL configuration module 934 may be configured to, for example, transmit a VIL configuration and/or a MGTA configuration based on the VIL-type received in UE capability information.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
a transceiver; and
a processor configured to:
transmit, from the UE to a base station and via the transceiver, UE capability information identifying a visible interruption length type (VIL-type) supported by the UE; and
receive, from the base station and via the transceiver, a visible interruption length (VIL) configuration, the VIL configuration corresponds with the UE capability information transmitted to the base station and a frequency range for performing UE measurements, the frequency range is a frequency range 2-2 (FR2-2).

2. The UE of claim 1, wherein:
the VIL-type is determined based on physical layer (PHY) parameters of baseband circuitry of the UE.

3. The UE of claim 1, wherein the VIL configuration describes a VIL as a number of interrupted slots.

4. The UE of claim 3, wherein the number of interrupted slots corresponds to a subcarrier spacing (SCS) configured on the FR2-2.

5. The UE of claim 1, further comprising:
determining a baseband preparation time required for the UE to perform the UE measurement based on the VIL-type supported by the UE.

6. The UE of claim 5, wherein the baseband preparation time is 0.25 milliseconds (ms).

7. The UE of claim 5, wherein the VIL configuration includes a VIL of 0.5 ms based on the baseband preparation time of 0.25 ms and a radio frequency (RF) retuning time of 0.25 ms.

8. The UE of claim 5, wherein the baseband preparation time is 0.5 milliseconds (ms).

9. The UE of claim 5, wherein the VIL configuration includes a VIL of 0.75 ms based on the baseband preparation time of 0.5 milliseconds (ms) and an RF retuning time of 0.25 ms.

10. The UE of claim 1, wherein the VIL configuration further corresponds with performing the UE measurements in a frequency range 1 (FR1) or a frequency range 2-1 (FR2-1).

11. The UE of claim 1, wherein the VIL configuration includes a first VIL period and a second VIL period, the second VIL period is different from the first VIL period, the first VIL period is before a measurement length (ML) period in which the UE performs the measurements, and the second VIL period is after the ML period.

12. The UE of claim 1, wherein:
the processor is further configured to:
receive, from the base station and via the transceiver, a measurement gap timing advance (MGTA) configuration, the MGTA configuration corresponds with the VIL configuration; and
the MGTA configuration includes an MGTA of 0 milliseconds (ms), 0.25 ms, 0.5 ms, or 0.75 ms.

13. A base station, comprising:
a transceiver; and
a processor configured to:
transmit, to a user equipment (UE) and via the transceiver, a visible interruption length (VIL) configuration, the VIL configuration corresponds with a VIL-type identified by UE capability information received from the UE for performing UE measurements for a frequency range; and
transmit, to the UE and via the transceiver, a measurement gap timing advance (MGTA) configuration, the MGTA configuration corresponds with the VIL configuration, the frequency range is a frequency range 2-2 (FR2-2).

14. The base station of claim 13, wherein the VIL-type is determined based on physical layer (PHY) parameters of baseband circuitry of the UE.

15. The base station of claim 13, wherein the VIL configuration includes a VIL as a number of interrupted slots or a time in milliseconds (ms).

16. The base station of claim 13, wherein the VIL configuration includes:
a VIL of 0.5 milliseconds (ms) that includes a baseband preparation time of 0.25 ms and an RF retuning time of 0.25 ms; or
a VIL of 0.75 ms that includes a baseband preparation time of 0.5 ms and an RF retuning time of 0.25 ms.

17. The base station of claim 13, wherein the measurement gap timing advance (MGTA) configuration indicates an MGTA as a number of interrupted slots, the number of interrupted slots corresponds to a subcarrier spacing (SCS) configured on a frequency range.

18. A method comprising:
receiving, from a user equipment (UE) and at a base station communicatively coupled with the UE, UE capability information identifying a visible interruption length type (VIL-type) supported by the UE for a frequency range, the frequency range is a frequency range 2-2 (FR2-2);
transmitting, from the base station to the UE, a visible interruption length (VIL) configuration for performing UE measurements based on the VIL-type, the VIL configuration indicating a VIL as a number of interrupted slots or a first time in milliseconds (ms); and
transmitting, from the base station to the UE, a measurement gap timing advance (MGTA) configuration according to the VIL configuration, the MGTA configuration indicating an MGTA as a second number of interrupted slots or a second time in ms.

19. The method of claim 18, wherein:
the first time is 0.5 ms or 0.75 ms; and
the second time is one of: 0 ms, 0.25 ms, 0.5 ms, and 0.75 ms.

20. The method of claim 18, wherein the second time of 0.5 ms is used to align with the first time of 0.5 ms, and the second time of 0.75 ms is used to align with the first time of 0.75 ms.
